(19) United States
(12) Patent Application Publication
(10) Pub. No.: US 2006/0067335 A1
(43) Pub. Date: Mar. 30, 2006

(54) Method of managing a network system for a storage system

(76) Inventors: Yuzuru Maya, Sagamihara (JP); Yutaka Enko, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/988,563

(22) Filed: Nov. 16, 2004

(30) Foreign Application Priority Data
Sep. 28, 2004 (JP) 2004-281253

(51) Int. Cl. H04L 12/56; H04L 12/28

(52) U.S. Cl. 370/397

(57) ABSTRACT

Provided is a method of managing a network system including a computer device which processes data, a storage system which is used in the computer device to store data, and a switch which connects the computer device and the storage system to each other. The storage system sets VLANs and the priority of each of the VLANs on the switch, VLANs including at least one of a control VLAN transferring mainly control data, and at least one of a user VLAN transferring data other than the control data. The switch transfers data in a manner that allows the VLANs of higher priority to precede the VLANs of lower priority. Therefore the storage system manages a network in accordance with the level of load or the like of respective VLANs.

### CLAIM OF PRIORITY

The present application claims priority from Japanese application P2004-281253 filed on Sep. 28, 2004, the content of which is hereby incorporated by reference into this application.

### BACKGROUND

This invention relates to a network system having network-attached storage and, more specifically, a technology of setting priority to plural VLANs.

Network systems having network-attached storage (NAS) have recently come into existence. The emergence of such network systems has created the need for a system that is capable of managing a complicated network.

An example of the management system for a complicated network is a network distributed management system (see JP 2001-144761 A, for example). The network distributed management system divides a network into network groups and provides a network monitoring server or a network monitoring terminal for each network group, so that the network is managed by plural network monitoring servers or network monitoring terminals.

Another example is network management that uses the VLAN (Virtual Local Area Network) technology. With the VLAN technology, no special hardware is necessary in virtually constructing a number of LANs.

### SUMMARY

According to the network distributed management system of JP 2001-144761 A, an increase in load at some point on the network prolongs the response time of other network terminals, which lowers the quality of service. This is because lines dedicated to communications of control data including information of load of each network are not connected to the network management servers and network management terminals. Thus a delay of control information in a network that is under a great load causes a prolonged response time in other network terminals.

In application of the VLAN technology to a network system with NAS, an increase in load of one VLAN affects the rest of VLANs. This is because, in NAS, the same CPU, memory and others are shared in processing of data input/output from different VLANs.

This invention has been made in view of the above problems, and it is therefore an object of this invention to provide a method of managing a network system for a storage system in which NAS manages a network in accordance with the level of load or the like of respective VLANs.

According to a embodiment of this invention, there is provided a method of managing a network system including a computer device which processes data, a storage system which is used in the computer device to store data, and a switch which connects the computer device and the storage system to each other, in which the storage system sets a control VLAN, a user VLAN, and the priority of each of the VLANs on the switch, the control VLAN transferring mainly control data, the user VLAN transferring data other than the control data, and in which the switch transfers data in a manner that allows the VLANs of higher priority to precede the VLANs of lower priority.

According to a embodiment of this invention, it is possible to facilitate management of a network by providing the network with a control VLAN, which is dedicated to communications of control information of user VLANs.

### BRIEF DESCRIPTION OF THE DRAWINGS

The present invention can be appreciated by the description which follows in conjunction with the following figures, wherein:

FIG. 1 is a system configuration diagram of a network system according to a first embodiment of this invention.

FIG. 2 is an explanatory diagram outlining processing of the network system according to the first embodiment of this invention.

FIG. 3 is an explanatory diagram outlining processing of the network system according to the first embodiment of this invention.

FIG. 4 is a block diagram of NAS according to the first embodiment of this invention.

FIG. 5 is a block diagram of a directly connected L2 switch according to the first embodiment of this invention.

FIG. 6 is a configuration diagram of a VLAN priority table stored in the NAS according to the first embodiment of this invention.

FIG. 7 is an explanatory diagram of processing of L2 switches based on priority in the first embodiment of this invention.

FIG. 8 is a configuration diagram of a monitoring table stored in the NAS according to the first embodiment of this invention.

FIG. 9 is a configuration diagram of an event packet according to the first embodiment of this invention.

FIG. 10 is a configuration diagram of a traffic packet according to the first embodiment of this invention.

FIG. 11 is a configuration diagram of a priority modify packet according to the first embodiment of this invention.

FIG. 12 is a relation table of addresses used in the event packet and traffic packet according to the first embodiment of this invention.

FIG. 13 is a relation table of addresses used in the priority modify packet according to the first embodiment of this invention.

FIG. 14 is a flow chart of processing of the network system for when an event A occurs in the first embodiment of this invention.

FIG. 15 is a flow chart of processing of the NAS for when the event A occurs in the first embodiment of this invention.

FIG. 16 is a flow chart of processing of the network system for when there is a change of traffic information in a user VLAN1 in the first embodiment of this invention.

FIG. 17 is a flow chart of processing of the NAS for when there is a change of traffic information in the user VLAN1 in the first embodiment of this invention.

FIG. 18 is a configuration diagram of a VLAN priority table according to a second embodiment of this invention.

FIG. 19 is a configuration diagram of a VLAN priority table according to a third embodiment of this invention.

FIG. 20 is a configuration diagram of a VLAN priority table according to a fourth embodiment of this invention.

FIG. 21 is a configuration diagram of a VLAN priority table that is used when a control VLAN is unavailable in a fifth embodiment of this invention.

FIG. 22 is a flow chart of processing of NAS that makes a control VLAN unavailable in the fifth embodiment of this invention.

FIG. 23 is a system configuration diagram of a network system according to a sixth embodiment of this invention.

FIG. 24 is a flow chart of processing of control VLAN for when a fault occurs in the sixth embodiment of this invention.

### DETAILED DESCRIPTION OF THE PREFERRED EMBODIMENTS

Embodiments of this invention will be described below with reference to the accompanying drawings.

### First Embodiment

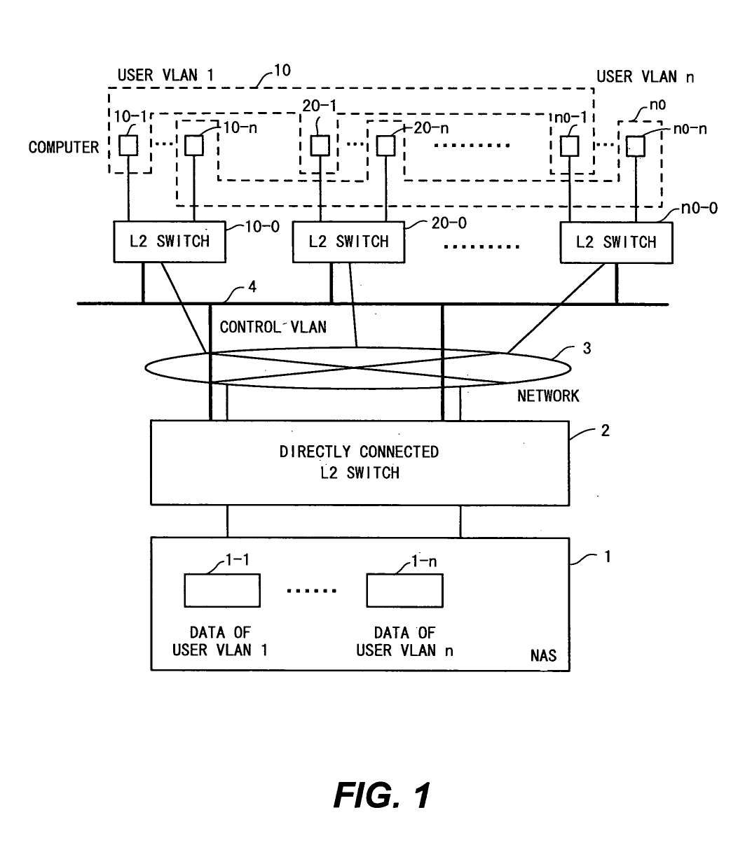

FIG. 1 is a system configuration diagram of a network system according to a first embodiment of this invention. The network system of the first embodiment is composed of NAS 1, a directly connected L2 switch 2, a network 3, L2 switches 10-0 to n0-0, and terminals 10-1 to 10-n, 20-1 to 20-n, . . . , and n0-1 to n0-n.

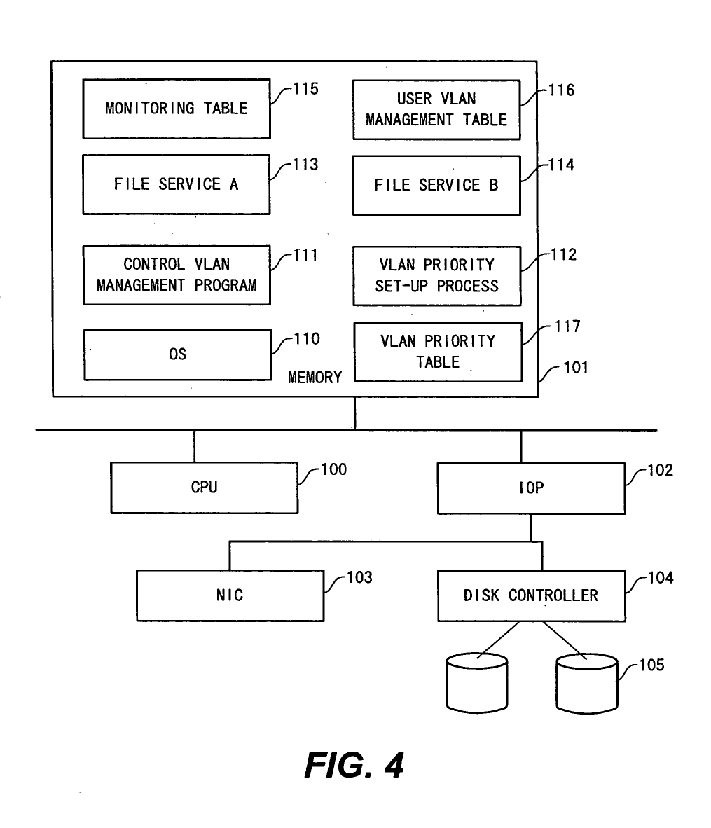

The network attached storage (NAS) 1 is a storage system directly connected to the network to exchange data with the network. The NAS 1 is composed of a disk drive and a control unit which controls data input/output to the disk drive (see FIG. 4 for details). The NAS 1 is a dedicated file server having a file sharing function, which allows the terminals 10-1 to 10-n to access common files, and other functions.

The following description on embodiments of this invention deals with a case in which NAS controls VLANs set to a network. However, this invention is also applicable in the manner described below to an NAS head or like other storage system that has a control unit but not a disk drive.

The directly connected L2 switch 2 is a switch directly connected to the NAS 1 to judge the destination of a packet in a data link layer of the OSI reference model and transfer the packet. The NAS 1 and the directly connected L2 switch 2 may be integrated with each other.

The L2 switches 10-0 to n0-0 are switches directly connected to the terminals 10-1 to 10-n to judge the destination of a packet in a data link layer of the OSI reference model and transfer the packet. The directly connected L2 switch 2 and the L2 switches 10-0 to n0-0 transfer packets via the network 3.

In the network system of the first embodiment, one physical LAN is divided into (n+1) VLANs. The (n+1) VLANs here are n user VLANs 10 to no and one control VLAN 4.

The user VLANs 10 to n0 make groups of the terminals 10-1 to 10-n, 20-1 to 20-n, . . . , and n0-1 to n0-n, and the terminals in each group constitute a virtual LAN. This means that the terminals belonging to the same user VLAN can access each other but cannot access the terminals belonging to other VLANs.

The terminals 10-1 to 10-n, 20-1 to 20-n, . . . , and n0-1 to n0-n which respectively belong to the user VLANs 10 to n0 can store data in the NAS 1. The NAS 1 manages stored data 1-1 to 1-n separately for each of the user VLANs 10 to n0. The terminals in the same user VLAN can access one another's data but not data of the terminals in the rest of user VLANs.

The control VLAN 4 is a virtual LAN which is connected to all of the L2 switches 10-0 to n0-0 and to the directly connected L2 switch 2 and which is dedicated to communications of control information. Control information contains event information or traffic information. Event information is information of data that is about to be communicated, and refers to data type such as streaming data and backup data. Traffic information is about the data transfer amount per unit time of the user VLANs 10 to n0.

Owing to the control VLAN 4, the NAS 1 in the network system according to the first embodiment of this invention can quickly obtain control information of every one of the user VLANs 10 to n0 and can therefore balance load throughout the user VLANs 10 to n0.

Described next is the outline of the operation of the network system according to the first embodiment of this invention.

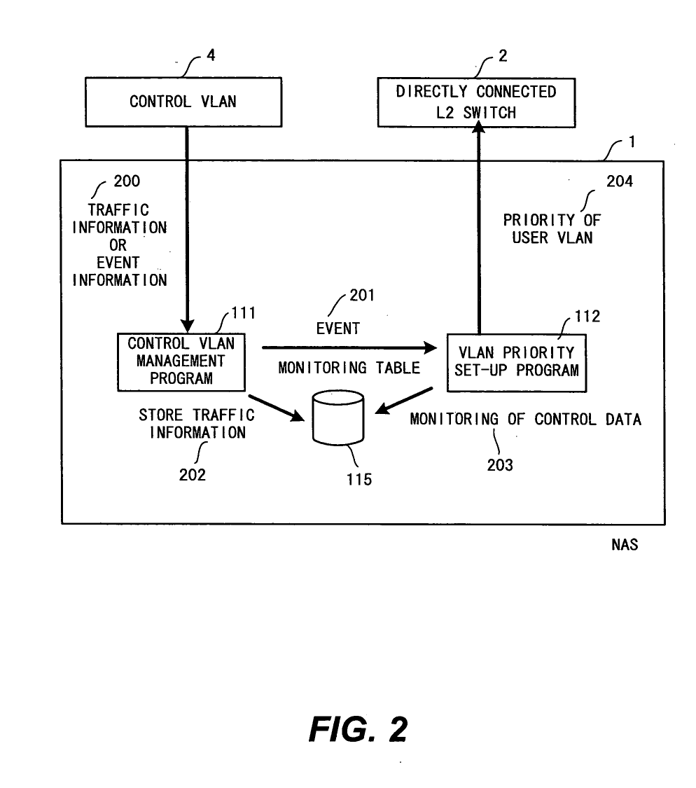

FIG. 2 is an explanatory diagram outlining network system processing according to the first embodiment of this invention.

FIG. 2 shows the operation of the control VLAN 4, the NAS 1, and the directly connected L2 switch 2. The NAS 1 has a control VLAN management program 111, a VLAN priority set-up program 112, and a monitoring table 115.

The NAS 1 first executes the control VLAN management program 111. The control VLAN management program 111 receives event information or traffic information (control information) from the control VLAN 4 (200). The control VLAN management program 111 judges whether the received control information is event information or traffic information.

In the case where the received control information is judged to be event information, the control VLAN management program 111 notifies the VLAN priority set-up program 112 of occurrence of an event (201). Notified of the event, the VLAN priority set-up program 112 sets an order of priority to the user VLANs 10 to n0 in accordance with the event information.

When there is a change in priority of the user VLANs 10 to n0, the VLAN priority set-up program 112 requests the directly connected L2 switch 2 to change the order of priority of the user VLANs 10 to n0 (204). Receiving the request of change of priority, the directly connected L2 switch 2 changes the order of priority of the user VLANs 10 to n0.

On the other hand, in the case where the received control information is judged to be traffic information, the control VLAN management program 111 stores the traffic information in the monitoring table 115 (202). The VLAN priority set-up program 112 monitors the monitoring table periodically (203) to set an order of priority to the user VLANs 10 to n0 in accordance with the traffic volume.

When there is a change in priority of the user VLANs 10 to n0, the VLAN priority set-up program 112 requests the directly connected L2 switch 2 to change the order of priority of the user VLANs 10 to n0 (204). Receiving the request of change of priority, the directly connected L2 switch 2 changes the order of priority of the user VLANs 10 to n0.

According to the outline of the first embodiment shown in FIG. 2, the NAS 1 sets an order of priority that suits control information received from the control VLAN 4 to the directly connected L2 switch 2.

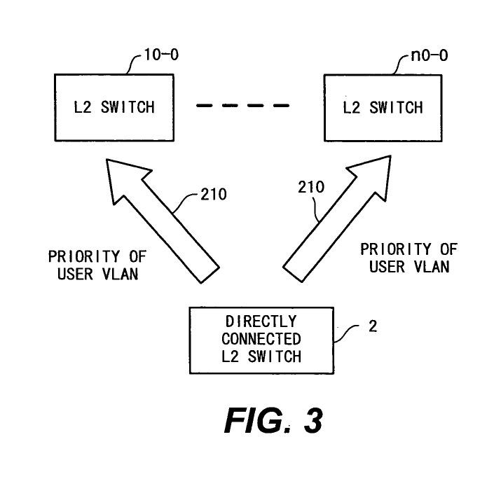

FIG. 3 is an explanatory diagram outlining processing of the network system according to the first embodiment of this invention.

FIG. 3 shows the operation of the directly connected L2 switch 2 and the L2 switches 10-0 to n0-0.

After changing the order of priority of the user VLANs 10 to n0, the directly connected L2 switch 2 requests every one of the L2 switches 10-0 to n0-0 to change the priorities of the user VLANs 10 to n0 (210). Receiving the request of change of priority, the L2 switches 10-0 to n0-0 change the priorities of the user VLANs 10 to n0.

According to the outline of the first embodiment shown in FIG. 3, the user VLANs 10 to n0 are all set to the same priority level by the directly connected L2 switch 2 and the L2 switches 10-0 to n0-O.

Such processing is achieved by details of the network system according to the first embodiment of this invention which will be described below.

FIG. 4 is a block diagram of the NAS 1 according to the first embodiment of this invention.

The NAS 1 is composed of a CPU 100, a memory 101, an input output processor (IOP) 102, a network interface controller (NIC) 103, a disk controller 104, and a disk drive 105.

The memory 101 stores an OS (Operating System) 110, the control VLAN management program 111, the VLAN priority set-up program 112, a file service A 113, a file service B 114, the monitoring table 115, a user VLAN management table 116, and a VLAN priority set-up table 117. Various information stored in the memory 101 are inputted by a terminal (management server) connected to the NAS 1 via the network 3.

The CPU 100 loads and executes the programs 110, 111, and 112 stored in the memory 101 to perform various processing.

The IOP 102 controls data input and output of the NIC 103. The NIC 103 is an interface that is connected to the directly connected L2 switch 2 via the Ethernet. The disk controller 104 controls data input/output to the disk drive 105. The disk drive 105 stores data of the terminals 10-1 to 10-n, 20-1 to 20-n, . . . , and n0-1 to n0-n.

The control VLAN management program 111 manages control information received from the control VLAN 4. The VLAN priority set-up program 112 sets the priority that suits the received control information to the directly connected L2 switch 2.

The file service A 113 and the file service B 114 are, for example, NFS and samba, and provide a file sharing service to the terminals 10-1 to 10-n, 20-1 to 20-n, . . . , and n0-1 to n0-n. The monitoring table 115 stores traffic information of the user VLANs 10 to n0.

The user VLAN management table 116 stores the priorities of the user VLANs 10 to n0. The VLAN priority table 117 stores the association relation between control information and priority.

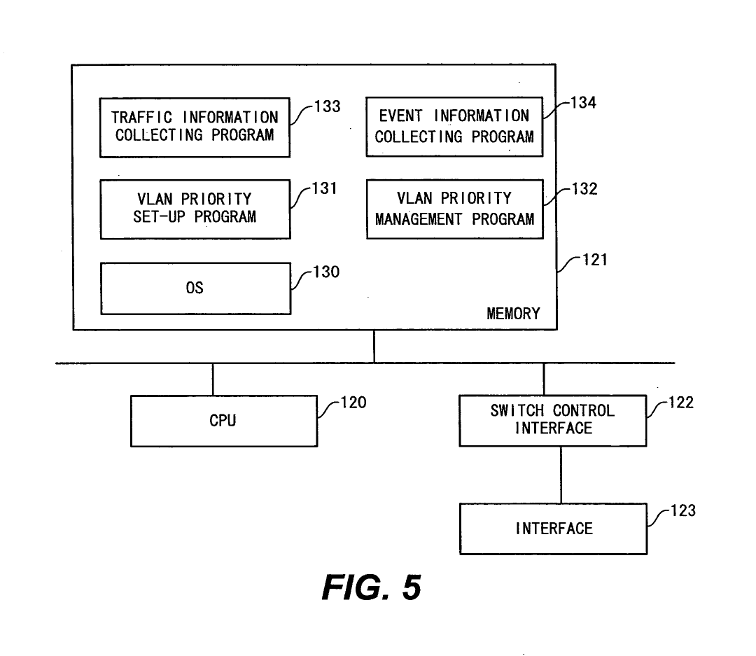

FIG. 5 is a block diagram of the directly connected L2 switch 2 according to the first embodiment of this invention.

The directly connected L2 switch 2 is the network's switch composed of a CPU 120, a memory 121, a switch control interface 122, and an interface 123.

The memory 121 stores an OS 130, a VLAN priority set-up program 131, a VLAN priority management table 132, a traffic information collecting program 133, and an event information collecting program 134. Various information stored in the memory 121 are inputted by a terminal connected to the directly connected L2 switch 2 via the network 3.

The CPU 120 loads and executes the programs 130 to 134 stored in the memory 121 to perform various processing.

FIG. 5 shows only one interface 123 but actually there is more than one interface 123 connected to the NAS 1 and the network 3. The switch control interface 122 is connected to a terminal or the like, through which the directly connected L2 switch 2 is controlled.

The VLAN priority set-up program 131 sets an order of priority to the user VLANs 10 to n0. The VLAN priority management program 132 stores the priorities of the user VLANs 10 to n0 in a given area of the memory 121.

The traffic information collecting program 133 collects traffic information to send the collected information to the NAS 1. The event information collecting program 134 collects event information to send the collected information to the NAS 1.

The L2 switches 10-0 to n0-0 have the same configuration as the directly connected L2 switch 2.

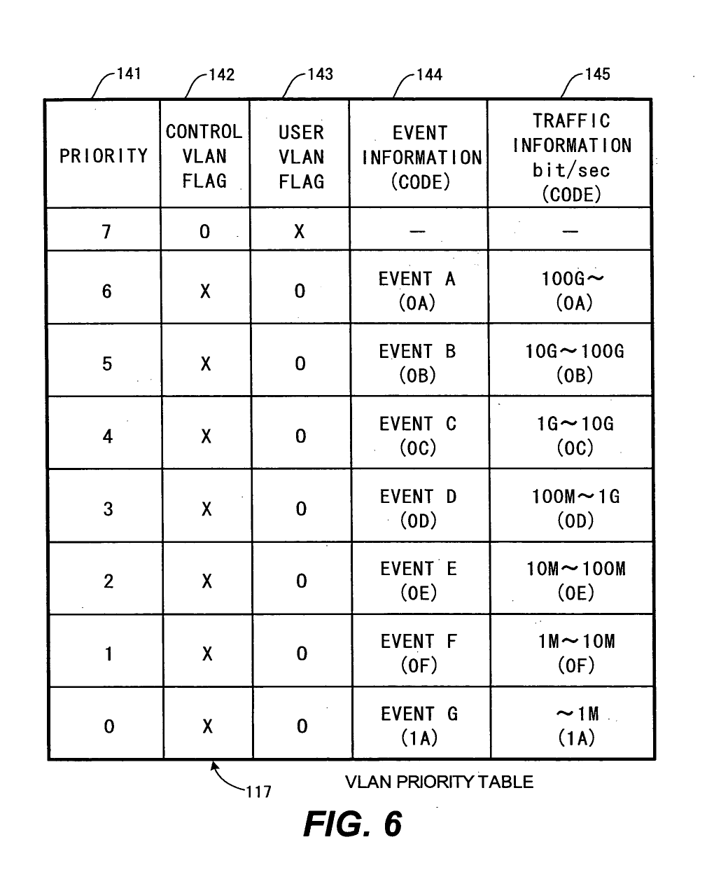

FIG. 6 is a configuration diagram of the VLAN priority table 117 stored in the NAS 1 according to the first embodiment of this invention.

The VLAN priority table 117 is composed of a priority 141, a control VLAN flag 142, a user VLAN flag 143, event information 144, and traffic information 145.

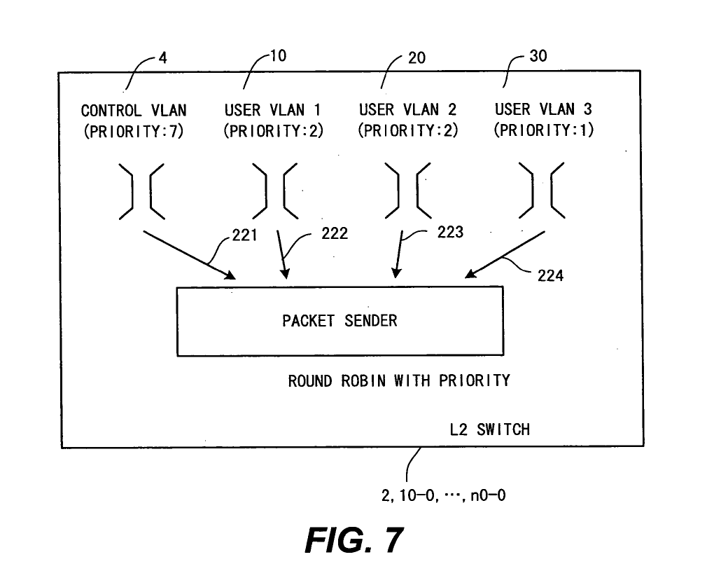

The priority 141 is the order in which the L2 switches 10-0 to n0-0 send data. In this embodiment, the priority 141 has eight levels, “0” to “7”, with the level “7” being the highest priority and gradually lowering toward the level “0”. The L2 switches 10-0 to n0-O send, as will be described with reference to FIG. 7, data of the highest priority first.

The control VLAN flag 142 indicates how the priority of a related record is allotted to the control VLAN 4. In this embodiment, the priority level “7” is allotted to the control VLAN 4 in order to give priority to communications of control information.

The user VLAN flag 143 indicates how the priorities of related records are allotted to the user VLANs 10 to n0. In this embodiment, the priority levels “0” to “6” are allotted to the user VLANs 10 to n0.

The event information 144 holds the name of an event that is associated with the priority of a related record and the code that identifies the event. In this embodiment, an “event A” with an event information code “0A” is given a priority level of “6”. Similarly, a priority level of “5” is given to an “event B” with an event information code “0B” and the subsequent events down to an “event G” with an event information code “1A” are given their respective priority levels.

For instance, stream data such as audio data is handled as the “event A” of high priority to reduce delay in data transfer. Backup data or the like is handled as the “event G” of low priority to transfer other types of data first and thereby enhance the usability of the network system.

Priorities are also set to VLAN traffics. The traffic information 145 holds the data transfer amount per unit time and traffic information identifying code that are associated with the priority of a related record. In this embodiment, a traffic information code “0A” which means “100 Gbit/sec or more” is associated with the priority level “6”. Similarly, a traffic information code “0B” which means “10 Gbit/sec to 100 Gbit/sec” is associated with the priority level “5” and the subsequent traffic information codes down to one that means “below 1 Mbit/sec” are given their respective priorities.

This embodiment uses the data transfer amount per unit time for traffic information. Alternatively, response time or the number of times data is issued may be used as traffic information. The response time refers to a time it takes for the NAS 1 to receive a packet from the L2 switches 10-0 to n0-O and to send the result. The number of times data is issued refers to the number of times the NAS 1 is accessed.

In the network system of the first embodiment, the priority levels from “6” to down are set in a manner that gives higher priority to data of larger transfer amount to thereby process user VLANs that have a heavier load first. The load is thus evened out throughout the user VLANs 10 to n0.

As has been defined in the user VLAN flag 143, the event information 144 and the traffic information 145 in the first embodiment are applied only to the user VLANs 10 to n0.

In the case where event information and traffic information occur at the same time, various methods can be employed to determine the priority. For instance, the priority of either event information or traffic information that has higher priority is set as the priority of the corresponding VLAN. To give a specific example, the priority level is set to “5” when the event information code is “0E” whereas the traffic information code is “0B”. Alternatively, the priority of event information may be set as the priority of the corresponding VLAN irrespective of the priority of traffic information.

Now, a description is given on processing of the L2 switches 10-0 to n0-O based on priority.

FIG. 7 is an explanatory diagram of processing of L2 switches based on priority in the first embodiment of this invention.

A control VLAN 4, a user VLAN1 (10), a user VLAN2 (20), and a user VLAN3 (30) are connected to the L2 switches 10-0 to n0-O. Queues are provided in the L2 switches 10-0 to n0-O for each VLAN connected.

When data is sent from the VLANs, the L2 switches 10-0 to n0-0 store transmission packets in the corresponding queues. The L2 switches 10-0 to n0-0 then send packets in the order of priority set. In the case where packets have the same priority, the packets are sent round robin.

In this explanatory diagram, the control VLAN 4 has the priority level “7”, the user VLAN1 (10) has the priority level “2”, the user VLAN2 (20) has the priority level “2”, and the user VLAN3 (30) has the priority level “1”.

The L2 switches 10-0 to n0-O first send all packets stored in the queue for the control VLAN 4, which has the highest priority level “7” (221). Then the L2 switches 10-0 to n0-O send packets of the user VLAN1 (10) and the user VLAN2 (20) which have the second highest priority of the four. Since the user VLAN1 (10) and the user VLAN2 (20) have the same priority, their packets are sent alternately round robin (222, 223). The L2 switches 10-0 to n0-0 lastly send packets stored in the queue for the user VLAN3 (30), which has the lowest priority of the four (224).

Having the L2 switches 10-0 to n0-0 send packets in the order of priority makes it possible to execute processing of greater importance first. This also makes it possible to even out the load throughout the VLANs.

The directly connected L2 switch 2 sends packets based on priority similar to the L2 switches 10-0 to n0-0.

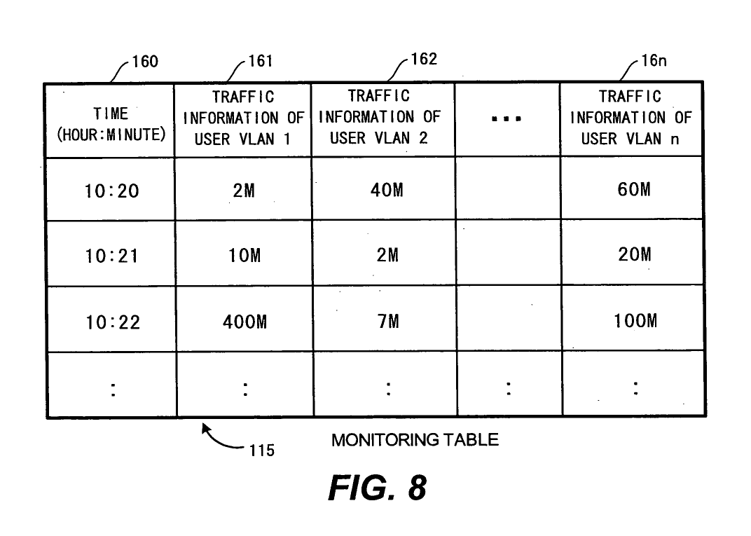

FIG. 8 is a configuration diagram of the monitoring table 115 stored in the NAS 1 according to the first embodiment of this invention.

The monitoring table 115 is composed of a time 160 and traffic information 161 to 16n of the respective user VLANs.

The time 160 is a time at which a record in question is stored in the monitoring table 115. The traffic information 161 to 16n of the user VLAN1 to user VLANn holds the data transfer amount per unit time of the user VLAN 1 (10) to user VLANn (n0).

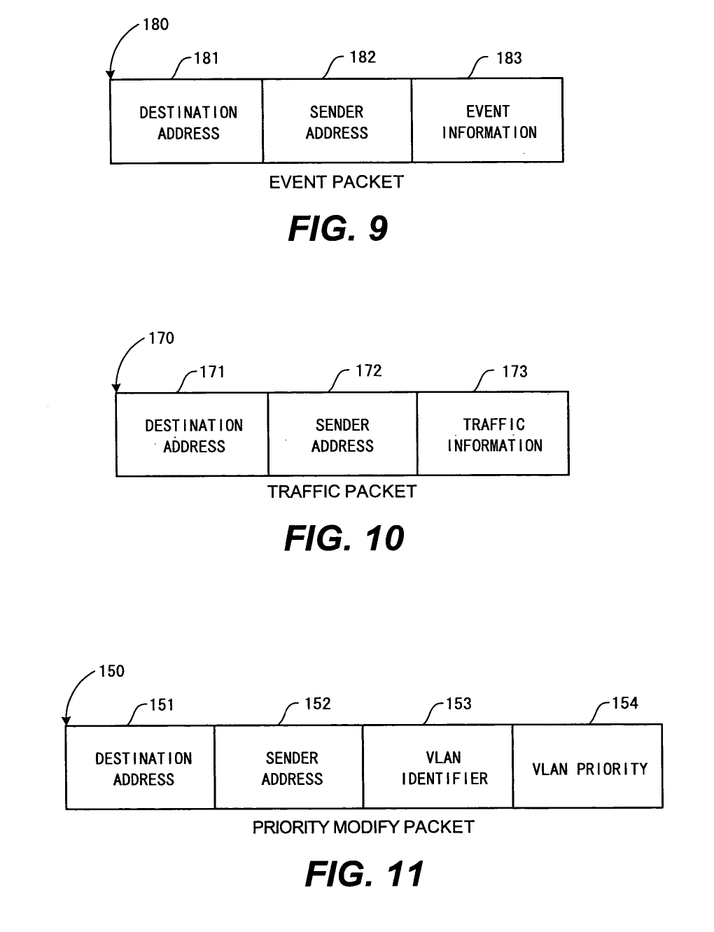

FIG. 9 is a configuration diagram of an event packet according to the first embodiment of this invention.

An event packet 180 is sent, when an event occurs, to the NAS 1 from the terminal 10-1 to 10-n, 20-1 to 20-n, . . . , and n0-1 to n0-n.

The event packet 180 contains a destination address 181, a sender address 182, and event information 183.

The destination address 181 is the address to which this packet is to be sent, and corresponds to the address of the NAS 1. The sender address 182 is the address of one of the user VLANs 10 to n0 to which the sender of this packet (one of the terminal 10-1 to 10-n, 20-1 to 20-n, . . . , and n0-1 to n0-n) belongs. The event information 183 holds a code that identifies event information of data that is about to be sent.

FIG. 10 is a configuration diagram of a traffic packet according to the first embodiment of this invention.

A traffic packet 170 is periodically sent to the NAS 1 from the terminal 10-1 to 10-n, 20-1 to 20-n, . . . , and n0-1 to n0-n.

The traffic packet 170 contains a destination address 171, a sender address 172, and traffic information 173.

The destination address 171 is the address to which this packet is to be sent, and corresponds to the address of the NAS 1. The sender address 172 is the address of one of the user VLANs 10 to n0 to which the sender of this packet (one of the terminal 10-1 to 10-n, 20-1 to 20-n, . . . , and n0-1 to n0-n) belongs. The traffic information 173 holds a code that identifies current traffic information.

FIG. 11 is a configuration diagram of a priority modify packet according to the first embodiment of this invention.

A priority modify packet 150 is sent, when the priorities of the user VLANs 10 to n0 are to be changed, from the NAS 1 to the directly connected L2 switch 2, or from the directly connected L2 switch 2 to every one of the L2 switches 10-0 to n0-0.

The priority modify packet 150 contains a destination address 151, a sender address 152, a VLAN identifier 153, and a VLAN priority 154.

The destination address 151 is an address to which this packet is to be sent. The sender address 152 is an address from which this packet is sent. The VLAN identifier 153 is an identifier of one of the user VLANs 10 to n0 whose priority is to be changed. The VLAN priority 154 shows a priority level set after the priority change for one of the user VLANs 10 to n0.

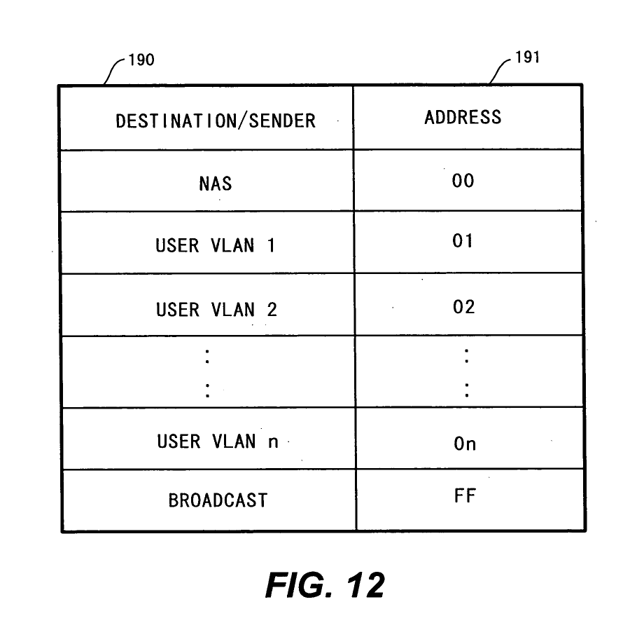

FIG. 12 is a relation table of addresses used in the event packet 180 and traffic packet 170 according to the first embodiment of this invention. The table defines which address is associated with a destination/sender 190.

The address relation table is stored in the terminal 10-1 to 10-n, 20-1 to 20-n, . . . , and n0-1 to n0-n, the L2 switches 10-0 to n0-0, and the NAS 1.

The destination address 181 and the sender address 182 in the event packet 180 are addresses listed as an address 191. The destination address 171 and the sender address 172 in the traffic packet 170 are also addresses listed as the address 191.

FIG. 12 shows addresses associated with the NAS and the VLANs. Specifically, the address of the NAS is “00”, the address of the user VLAN 1 is “01”, and the address of the user VLANn is “0n”. The address in broadcasting, where data is sent to every terminal in a segment, is “FF”.

The address 191 is also used as the VLAN identifier 153 of the priority modify packet 150.

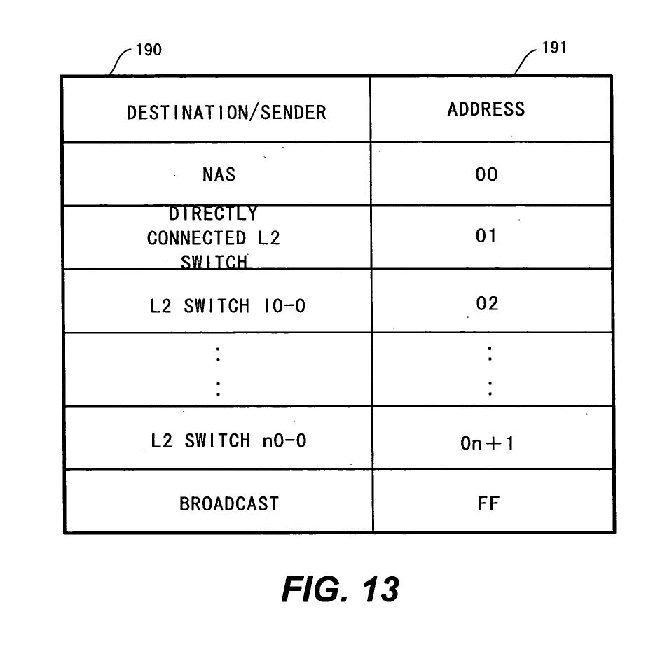

FIG. 13 is a relation table of addresses used in the priority modify packet 150 according to the first embodiment of this invention. The table defines which address is associated with a destination/sender 193.

The address relation table is stored in the directly connected L2 switch 2 and the NAS 1.

The destination address 151 and the sender address 152 in the priority modify packet 150 are addresses listed as an address 194.

In FIG. 13, the address of the NAS is “00”, the address of the directly connected L2 switch 2 is “01”, the address of the L2 switch 10-0 is “2”, and the address of the L2 switch n′0-0 is “0n+1”. The address in broadcasting, where data is sent to every terminal in a segment, is “FF”.

The description given next is about processing for when the event A occurs in the network system according to this invention.

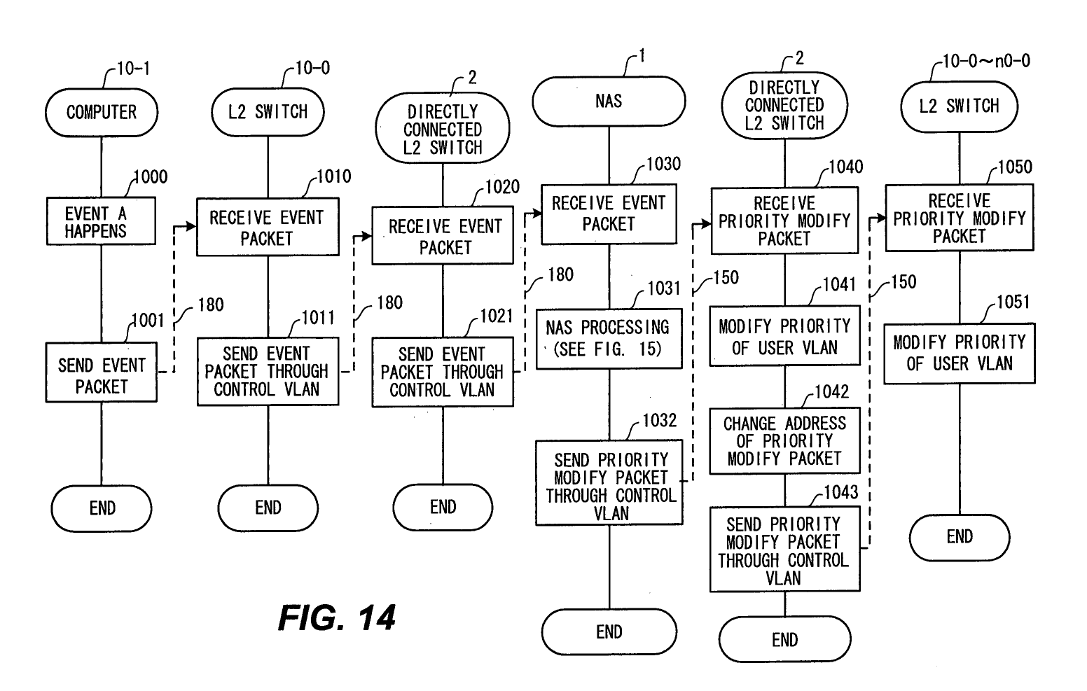

FIG. 14 is a flow chart of processing of the network system for when the event A occurs in the network system according to this invention.

Let us assume here that the event A with the priority level “6” occurs in the terminal 10-1 which belongs to the user VLAN1 (10) (1000).

The terminal 10-1 in which the event A has occurred creates the event packet 180 that indicates occurrence of the event A. The event packet 180 contains the address “00” of the NAS 1 as the destination address 181, the address “01” of the user VLAN1 (10) to which the terminal 10-1 belongs as the sender address 182, and the code “0A” of the event A as the event information 183.

The terminal 10-1 sends the created event packet 180 to the L2 switch 10-0 to which the terminal 10-1 is directly connected (1001).

The L2 switch 10-0 receives the event packet 180 from the terminal 10-1 (1010). The event packet 180 is stored in the queue for the control VLAN 4 by the L2 switch 10-0. Since the control VLAN 4 is set to the priority level “7”, the L2 switch 10-0 uses the control VLAN 4 to immediately send the event packet 180 to the directly connected L2 switch 2 (1011).

The directly connected L2 switch 2 receives the event packet 180 from the L2 switch 10-0 (1020). Using the control VLAN 4, the directly connected L2 switch 2 then sends the event packet 180 to the NAS 1 (1021).

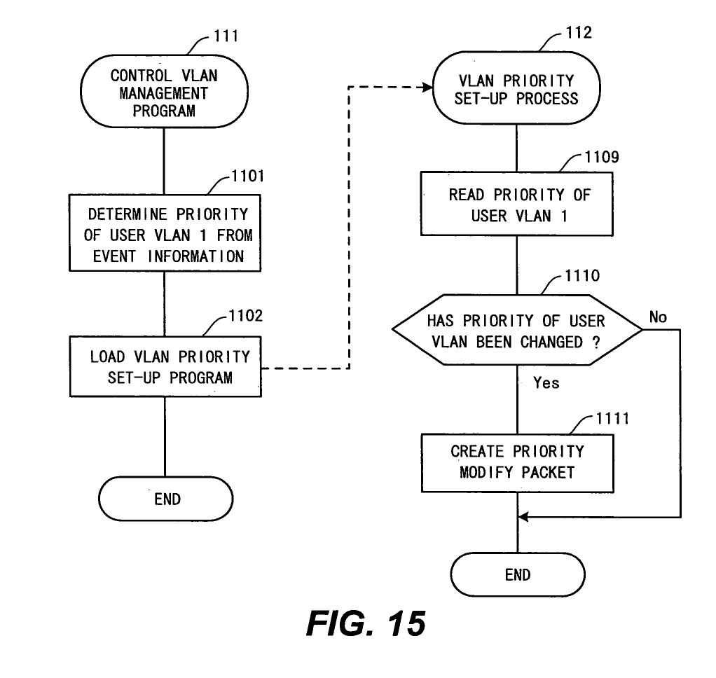

The NAS 1 receives the event packet 180 from the directly connected L2 switch 2 (1030). The NAS 1 then carries out processing illustrated in FIG. 15 (1031) to create the priority modify packet 150. The priority modify packet 150 stores the address “01” of the directly connected L2 switch 2 as the destination address 151, the address “00” of the NAS 1 as the sender address 152, the address “01” of the user VLAN1 as the VLAN identifier 153, and the priority level “6” of the event A as the VLAN priority 154.

The NAS 1 uses the control VLAN 4 to send the created priority modify packet 150 to the directly connected L2 switch 2 (1032).

The directly connected L2 switch 2 receives the priority modify packet 150 from the NAS 1 (1040). Referring to the priority modify packet 150, the directly connected L2 switch 2 changes the priority of one of the user VLANs 10 to n0 that is associated with the address stored as the VLAN identifier 153 to the VLAN priority 154 (1041). In this example, the directly connected L2 switch 2 changes the priority of the user VLAN1 (10) to the level “6”. A priority change by the directly connected L2 switch 2 is achieved by having the VLAN priority management program 132 change the priority stored in a given area of the memory 121.

Then the directly connected L2 switch 2 changes the destination address 151 and the sender address 152 in the received priority modify packet 150 (1042). In this example, the destination address 151 is changed to the address “FF” for broadcasting and the sender address 151 is changed to the address “01,” of the directly connected L2 switch 2. The directly connected L2 switch 2 uses the control VLAN 4 to send the address modify packet 150 with the addresses changed to every L2 switch (1043).

The L2 switches 10-0 to n0-0 receive the priority modify packet 150 (1050). The L2 switches 10-0 to n0-0 consult the priority modify packet 150 to change the priority of one of the user VLANs 10 to n0 that is associated with the address stored as the VLAN identifier 153 to the VLAN priority 154 (1051). In this example, the L2 switches 10-0 to n0-O change the priority of the user VLAN1 (10) to the level “6”. A priority change by the L2 switches 10-0 to n0-0 is achieved by having the VLAN priority management program 132 changes the priority stored in a given area of the memory 121.

Through the above processing, the NAS 1 changes the priority stored in the directly connected L2 switch 2 in accordance with event information. Furthermore, the directly connected L2 switch 2 makes the priority of the corresponding VLAN equal in every one of the L2 switches 10-0 to n0-0.

FIG. 15 is a flow chart of processing of the NAS 1 for when the event A occurs in the first embodiment of this invention.

The NAS 1 receives the event packet 180 from the directly connected L2 switch 2 (1030 of FIG. 14) and, upon reception, executes the control VLAN management program 111.

The control VLAN management program 111 chooses, from the VLAN priority table 117, a record in which the code of the event information 183 of the received event packet 180 and the code of the event information 144 match. The control VLAN management program 111 extracts the priority 141 of the chosen record. In this example, the code of the event information 183 is “0A” and therefore the level “6” of the priority 141 is extracted. The control VLAN management program 111 sets the extracted priority level “6” to the priority of the user VLAN (10) (1101).

Then the control VLAN management program 111 issues an order to start the VLAN priority set-up program (1102).

As the VLAN priority set-up program 112 is activated, the priority of one of the user VLANs 10 to n0 that is associated with the sender address 182 in the event packet 180 is read from the user VLAN management table 116 (1109). In this example, the address “01” is stored as the sender address 182 in the event packet 182 and therefore the priority of the user VLAN 1 (10) is read from the user VLAN management table 116.

Next, the VLAN priority set-up program 112 judges whether there is a change in user VLAN priority or not (1110). In this example, whether the priority read in the step S1109 is the level “6” or not is judged.

When there is no change in priority, the VLAN priority set-up program 112 is terminated at this point.

When there is a change in priority, on the other hand, the VLAN priority set-up program 112 creates the priority modify packet 150 (1111). The priority modify packet 150 stores the address “01,” of the directly connected L2 switch 2 as the destination address 151, the address “00” of the NAS 1 as the sender address 152, the address “01” of the user VLAN1 whose priority is changed as the VLAN identifier 153, and the priority level “6” of the event A as the VLAN priority 154. After creating the priority modify packet 150, the VLAN priority set-up program 112 is terminated.

Subsequently, the processing proceeds to the step S1032 of FIG. 14 to continue. The NAS 1 thus determines the priority and creates the priority modify packet 150 which is to be sent to the directly connected L2 switch 2.

The description given next is about processing for when traffic information is changed in the network system according to the first embodiment of this invention.

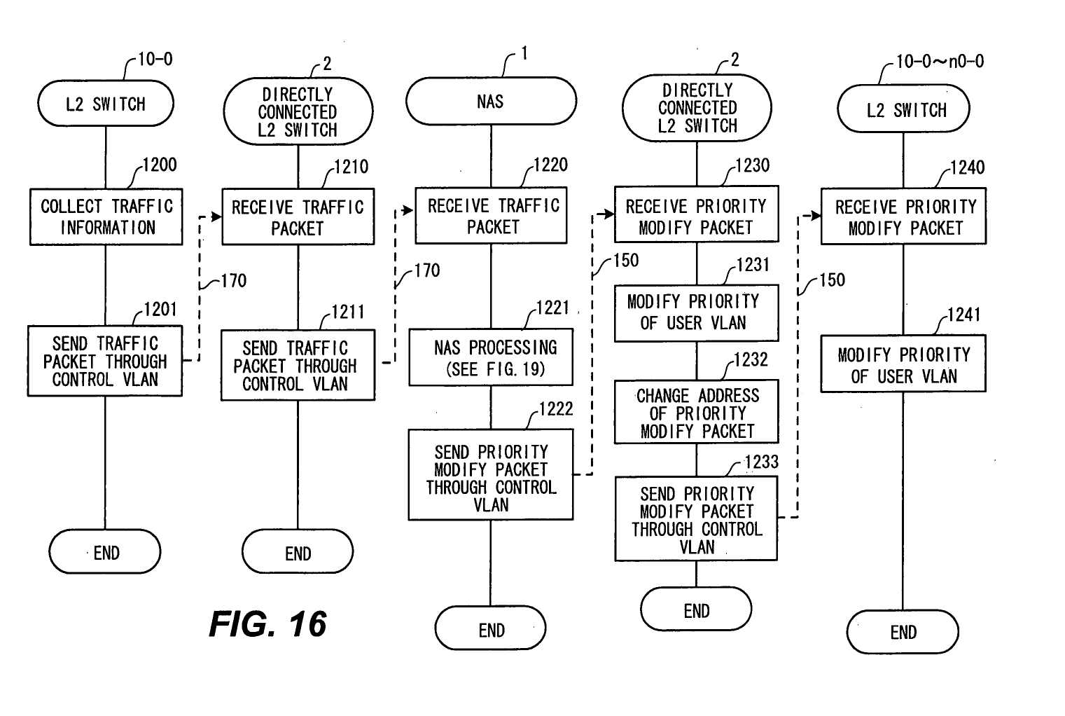

FIG. 16 is a flow chart of processing of the network system for when there is a change of traffic information in the user VLAN 1 in the first embodiment of this invention.

Assume that the data transfer amount per unit time of the user VLAN1 (10) has changed to 1.5 Gbit/sec. The L2 switch 10-0 uses the traffic information collecting program 133 to measure the data transfer amount per unit time and collect the measurements as traffic information (1200).

The L2 switch then creates the traffic packet 170. The traffic packet 170 stores the address “00” of the NAS 1 as the destination address 171, the address “01” of the user VLAN1 (10) as the sender address 172, and a code “0C”, which corresponds to a data transfer amount “1.5 G”, as the traffic information 173.

The L2 switch 10-0 uses the control VLAN 4 to send the created traffic packet 170 to the directly connected L2 switch 2 at a given timing (for example, periodically) (1201).

The directly connected L2 switch 2 receives the traffic packet 170 (1210). The directly connected L2 switch 2 uses the control VLAN4 to send the traffic packet 170 to the NAS 1 (a step S1211).

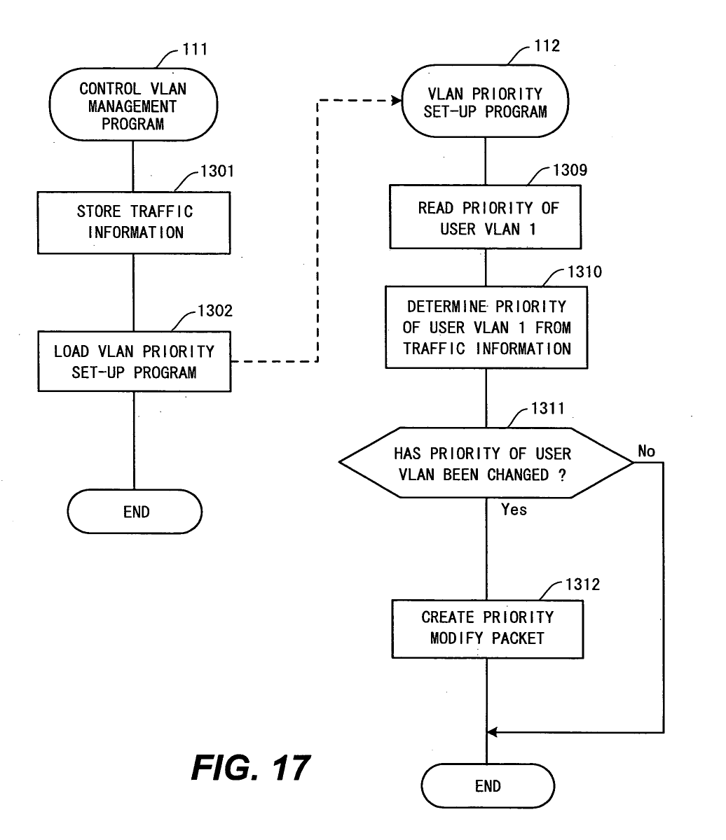

The NAS 1 receives the traffic packet 170 (1220). The NAS 1 then carries out processing illustrated in FIG. 17 (1221) to create the priority modify packet 150. The priority modify packet 150 in this example stores the address “01” of the directly connected L2 switch 2 as the destination address 151, the address “00” of the NAS 1 as the sender address 151, the address “01” of the user VLAN1 (10) as the VLAN identifier 153, and the priority level “4”, which corresponds to the data transfer amount “1.5 G”, as the VLAN priority 154.

The NAS 1 uses the control VLAN 4 to send the created priority modify packet 150 to the directly connected L2 switch 2 (1222).

The directly connected L2 switch 2 receives the priority modify packet 150 from the NAS 1(1230). The directly connected L2 switch 2 consults the priority modify packet 150 to change the priority of one of the user VLANs 10 to n0 that is associated with the address stored as the VLAN identifier 153 to the VLAN priority 154 (1231). In this example, the directly connected L2 switch 2 changes the priority of the user VLAN 1(10) to the level “4”.

Then the directly connected L2 switch 2 changes the destination address 151 and the sender address 152 in the received priority modify packet 150 (1232). In this example, the destination address 151 is changed to the address “FF” for broadcasting and the sender address 151 is changed to the address “01” of the directly connected L2 switch 2. The directly connected L2 switch 2 sends the address modify packet 150 with the addresses changed to every L2 switch (1233).

The L2 switches 10-0 to n0-O receive the priority modify packet 150 (1240). The L2 switches 10-0 to n0-0 consult the priority modify packet 150 to change the priority of one of the user VLANs 10 to n0 that is associated with the address stored as the VLAN identifier 153 to the VLAN priority 154 (1241). In this example, the L2 switches 10-0 to n0-O change the priority of the user VLAN1 (10) to the level “4”.

Through the above processing, the NAS 1 changes the priority stored in the directly connected L2 switch 2 in accordance with traffic information. Furthermore, the directly connected L2 switch 2 makes the priority of the corresponding VLAN equal in every one of the L2 switches 10-0 to n0-0.

FIG. 17 is a flow chart of processing of the NAS 1 for when traffic information is changed in the user VLAN1 (10) in the first embodiment of this invention.

The NAS 1 receives the traffic packet 170 from the directly connected L2 switch 2 (1220 of FIG. 16) and, upon reception, executes the control VLAN management program 111.

The control VLAN management program 111 extracts, from the traffic packet 170 received, the address “01” of the sender address 172 and the code “0c” of the traffic information 173. The control VLAN management program 111 then stores the extracted traffic information 173 in a record of the monitoring table 115 that is recorded at the time the traffic packet 170 is received (1301).

Then the control VLAN management program 111 issues an order to start the VLAN priority set-up program (1302).

As the VLAN priority set-up program 112 is activated, the priority of one of the user VLANs 10 to n0 that is associated with the sender address 172 in the traffic packet 170 is read from the user VLAN management table 116 (1309). In this example, the address “01” is stored as the sender address 172 in the traffic packet 172 and therefore the priority of the user VLAN 1 (10) is read from the user VLAN management table 116.

Next, the VLAN priority set-up program 112 chooses, from the VLAN priority table 117, a record in which the code of the traffic information 173 of the traffic packet 173 and the code of the traffic information 145 match. The VLAN priority set-up program 112 extracts the priority 141 of the chosen record. In this example, the code of the traffic information 173 is “0C” and therefore the level “4” of the priority 141 is extracted. The VLAN priority set-up program 112 sets the extracted priority level “4” to the priority of the user VLAN1 (10) (1310).

Next, whether there is a change in priorities in the user VLANs 10 to n0 or not is judged (1311). In this example, whether the priority read in the step S1309 is the level “4” or not is judged.

When there is no change in priority, the VLAN priority set-up program 112 is terminated at this point.

When there is a change in priority, on the other hand, the VLAN priority set-up program 112 creates the priority modify packet 150 (1312). The priority modify packet 150 stores the address “01” of the directly connected L2 switch 2 as the destination address 151, the address “00” of the NAS 1 as the sender address 152, the address “01” of the user VLAN1 whose priority is changed as the VLAN identifier 153, and the priority level “4” determined in the step S1310 as the VLAN priority 154. After creating the priority modify packet 150, the VLAN priority set-up program 112 is terminated.

Subsequently, the processing proceeds to the step S1222 of FIG. 16 to continue. The NAS 1 thus determines the priority and creates the priority modify packet 150 which is to be sent to the directly connected L2 switch 2.

The NAS 1 may create a priority modify packet using as traffic information the response time or the number of times data is issued.

In the network system having the NAS 1 according to the first embodiment of this invention, the control VLAN 4 is provided in addition to the user VLANs 10 to n0 as a constituent of VLANs. The control VLAN 4 is dedicated to communications of control data such as network load information. The control VLAN 4 is set to the highest priority in order to communicate control data first.

The NAS 1 collects control data from the control VLAN 4 to judge whether the priorities of the user VLANs 10 to n0 are optimum. In the case where the NAS 1 updates the priorities of the user VLANs 10 to n0, the directly connected L2 switch 2, which is directly connected to the NAS 1, is notified of the change. The directly connected L2 switch 2 further notifies every one of the L2 switches 10-0 to n0-0 of the priority change of the user VLANs 10 to n0, and makes the priority of the corresponding VLAN equal in all of the L2 switches 10-0 to n0-0.

With these functions, the network system of this embodiment manages the network in accordance with the load of the user VLANs 10 to n0, thus setting the optimum priority to each of the user VLANs 10 to n0 and balancing the load throughout the user VLANs 10 to n0. Moreover, the SLA (response time) can be kept constant by balancing the load throughout all the VLANs.

### Second Embodiment

In a second embodiment of this invention, communications of event information by the control VLAN 4 is given the highest priority.

The configuration and processing of a network system according to the second embodiment are the same as those of the first embodiment except the VLAN priority table 117 stored in the NAS 1. Therefore descriptions on points other than the VLAN priority management table 117 are omitted here.

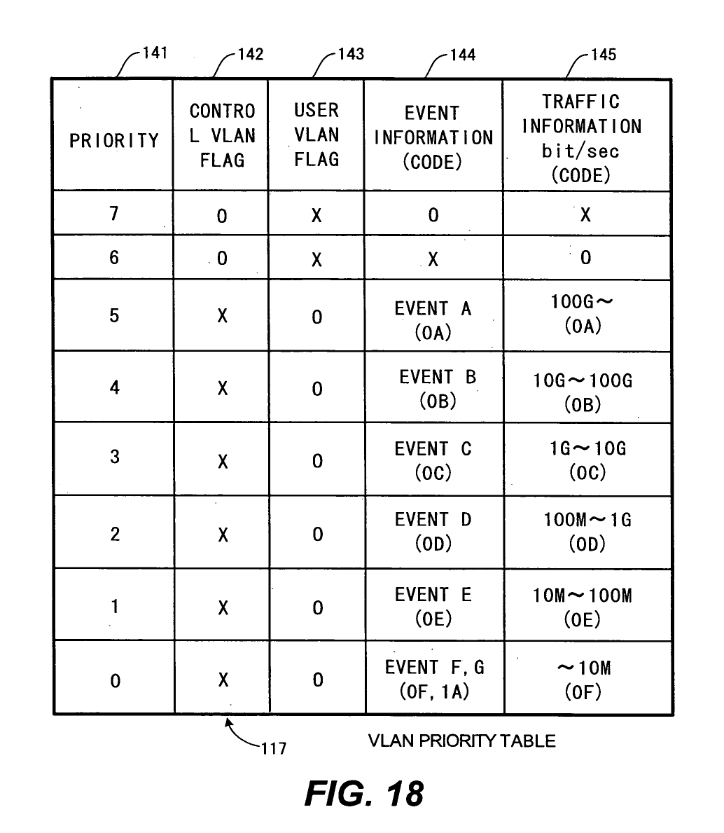

FIG. 18 is a configuration diagram of the VLAN priority table 117 according to the second embodiment of this invention.

The VLAN priority table 117 of the second embodiment is composed of the same items as those in the priority management table (FIG. 6) of the first embodiment and, accordingly, descriptions on details thereof will not be repeated.

In the VLAN priority table 117 of the second embodiment, the priority levels “7” and “6” are allotted to the control VLAN 4 whereas the priority levels “5” to “0” are allotted to the user VLANs 10 to n0. The priority level “7” is allotted to event information of the control VLAN 4, and the priority level “6” is allotted to traffic information of the control VLAN 4. In other words, communications of the event packet 180 is at the priority level “7” whereas communications of the traffic packet 170 is at the priority level “6”, thus giving the top priority to communications of the event packet 180.

That is, once an event occurs in the network system of the second embodiment, communications of the event packet 180 are given higher priority than in the first embodiment and the priorities of the user VLANs 10 to n0 can be set at high speed.

### Third Embodiment

In a third embodiment of this invention, communications of important event information by the control VLAN 4 is given a high priority.

The configuration and processing of a network system according to the third embodiment are the same as those of the first embodiment except the VLAN priority table 117 stored in the NAS 1. Therefore descriptions on points other than the VLAN priority management table 117 are omitted here.

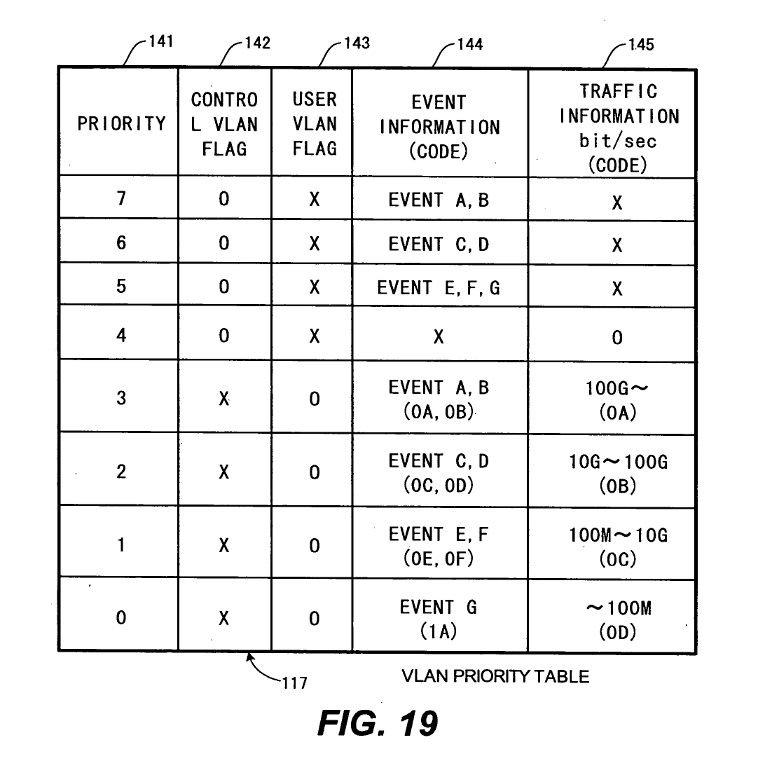

FIG. 19 is a configuration diagram of the VLAN priority table 117 according to the third embodiment of this invention.

The VLAN priority table 117 of the third embodiment is composed of the same items as those in the priority management table (FIG. 6) of the first embodiment and, accordingly, descriptions on details thereof will not be repeated.

In the VLAN priority management table 117 of the third embodiment, the priority levels “7” to “4” are allotted to the control VLAN 4 and the priority levels “3” to “0” are allotted to the user VLANs 10 to n0. Specifically, the priority level “7” is allotted to the events A and B of the control VLAN 4, the priority level “6” is allotted to events C and D of the control VLAN 4, the priority level “5” is allotted to events E, F, and G of the control VLAN 4, and the priority level “4” is allotted to traffic information of the control VLAN 4. In this way, the priority of event information is set in accordance with the degree of importance of the event.

In the network system of the third embodiment, communications of a packet of an event in question precedes transmission of other event packet 180 and the traffic packet 170 following the priority determined based on the type of event. As a result, the priorities of the user VLANs 10 to n0 can be set at higher speed than in the second embodiment.

### Fourth Embodiment

In a fourth embodiment of this invention, communications of high-load traffic information by the control VLAN 4 is given a high priority.

The configuration and processing of a network system according to the fourth embodiment are the same as those of the first embodiment except the VLAN priority table 117 stored in the NAS 1. Therefore descriptions on points other than the VLAN priority management table 117 are omitted here.

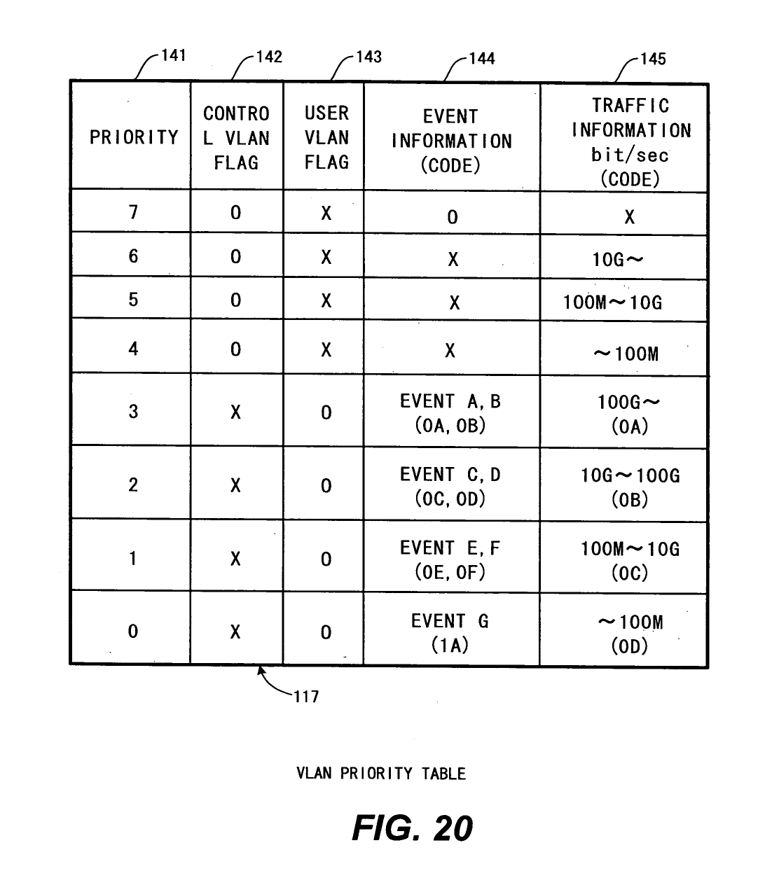

FIG. 20 is a configuration diagram of the VLAN priority table 117 according to the fourth embodiment of this invention.

The VLAN priority table 117 of the fourth embodiment is composed of the same items as those in the priority management table (FIG. 6) of the first embodiment and, accordingly, descriptions on details thereof will not be repeated.

In the VLAN priority management table 117 of the fourth embodiment, the priority levels “7” to “4” are allotted to the control VLAN 4 and the priority levels “3” to “0” are allotted to the user VLANs 10 to n0. Specifically, the priority level “7” is allotted to event information of the control VLAN 4, the priority level “6” is allotted to traffic information “10 G or more” of the control VLAN 4, the priority level “5” is allotted to traffic information “100 M to 10 G” of the control VLAN 4, and the priority level “4” is allotted to traffic information “below 100 M” of the control VLAN 4. In this way, the priority of event information is set in accordance with the degree of importance of the event.

The network system of the fourth embodiment sets the priority based on traffic information to give priority to communications of the traffic packet 170 of a user VLAN with a greater load. Therefore the load can be evened out at high speed throughout the user VLANs.

### Fifth Embodiment

In a fifth embodiment of this invention, the control VLAN 4 is temporarily made disable.

The configuration and processing of a network system according to the fifth embodiment are the same as those of the first embodiment except that two VLAN priority tables 117 and 118 are stored in the NAS 1. Therefore descriptions on points other than the configuration of the priority management table 118, which is used when the control VLAN is made disable, and processing of making the control VLAN 4 unusable are omitted here.

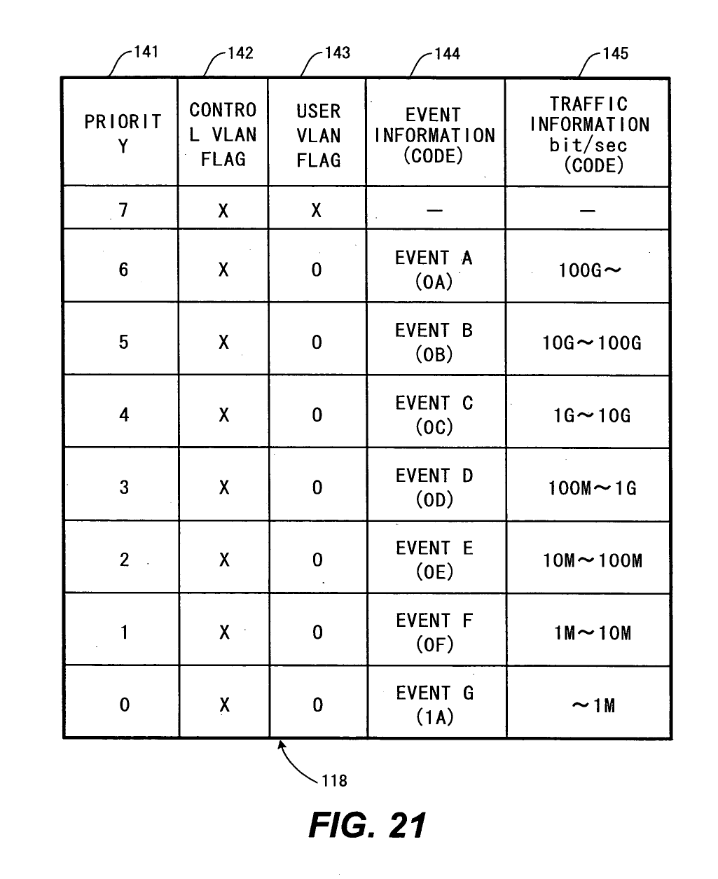

FIG. 21 is a configuration diagram of the VLAN priority management table 118 used when the control VLAN 4 is made disable in the fifth embodiment of this invention.

In the VLAN priority management table 118 for when the control VLAN 4 is made disable, the priority level “7” is allotted to none of the VLANs. The rest of the configuration is identical with that of the VLAN priority management table 117 in the first embodiment.

The priority control of user VLANs by the control VLAN 4 is not necessary if for what operation the network system is used is predetermined. In this case, turning the control VLAN 4 unusable makes it possible to avoid overhead, which is caused by the use of the control VLAN 4.

Processing of making the control VLAN 4 unusable will be described next.

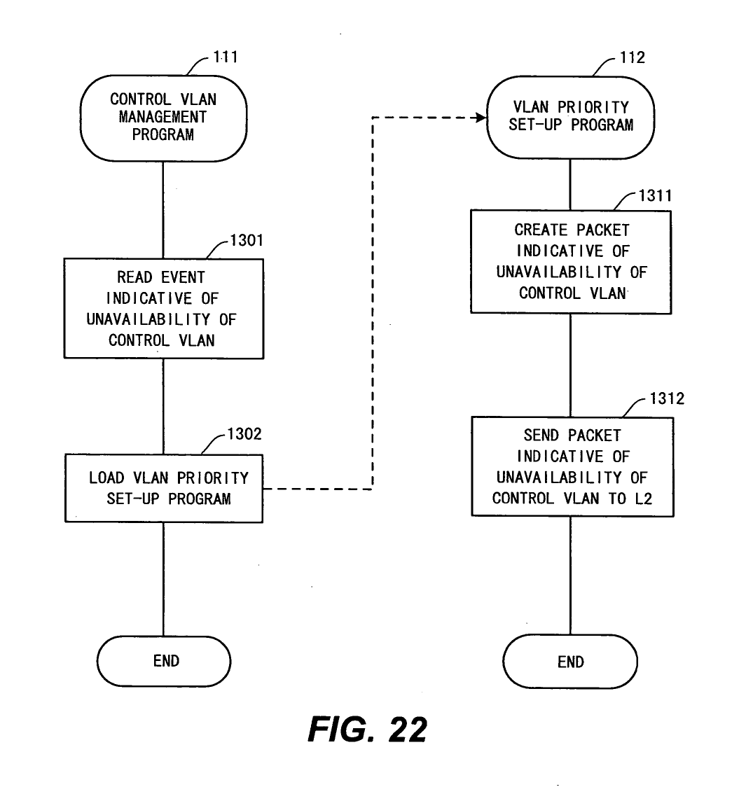

FIG. 22 is a flow chart of processing of the NAS 1 that makes the control VLAN 4 unusable in the fifth embodiment of this invention.

When the terminals 10-1 to 10-n, 20-1 to 20-n, . . . , and n0-1 to n0-n do not need to use the control VLAN 4, the terminals send the event packet 180 indicating that the control VLAN 4 is unusable to the NAS 1.

The control VLAN management program 111 of the NAS 1 reads an event in which the control VLAN 4 is unusable from the event information 183 of the received event packet 180 (1301). Then the program 111 issues an order to activate the VLAN priority set-up program (1302).

As the VLAN priority set-up program 112 is activated, a packet that instructs to make the control VLAN 4 unusable is created (1311) and sent to the directly connected L2 switch 2 (1312). Receiving the packet, the directly connected L2 switch 2 makes the control VLAN 4 unusable. The directly connected L2 switch 2 then sends the packet that instructs to make the control VLAN 4 unusable to every one of the L2 switches 10-0 to n0-0. The control VLAN 4 is made disable in the network system through this processing.

### Sixth Embodiment

In a sixth embodiment of this invention, the control VLAN 4 of a network system is duplicated.

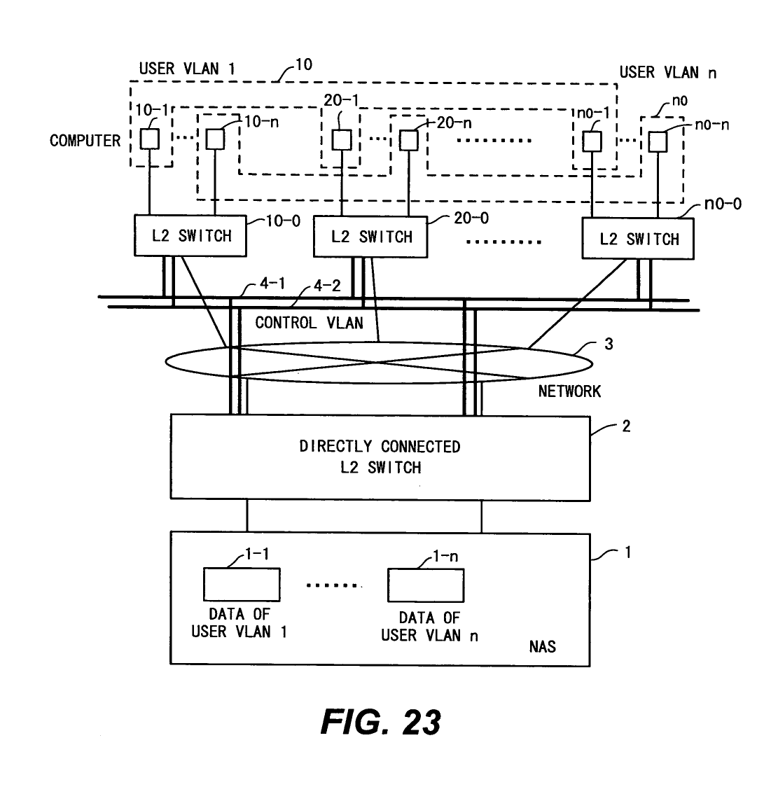

FIG. 23 is a system configuration diagram of a network system according to the sixth embodiment of this invention.

The configuration of the network system according to the sixth embodiment is the same as that of the network system in the first embodiment except that the control VLAN 4 is duplicated. Detailed descriptions are therefore omitted here.

The network system of the sixth embodiment divides one physical LAN into (n+2) VLANs. The (n+2) VLANs are composed of n user VLANs 10 to n0 and two control VLANs 4-1 and 4-2. With this redundant configuration, a fault in one of the control VLANs 4-1 and 4-2 does not prevent processing from continuing.

Although two control VLANs are set in the sixth embodiment, the network system of this embodiment may have more than two control VLANs.

Processing of the control VLANs 4-1 and 4-2 upon occurrence of a fault will be described next.

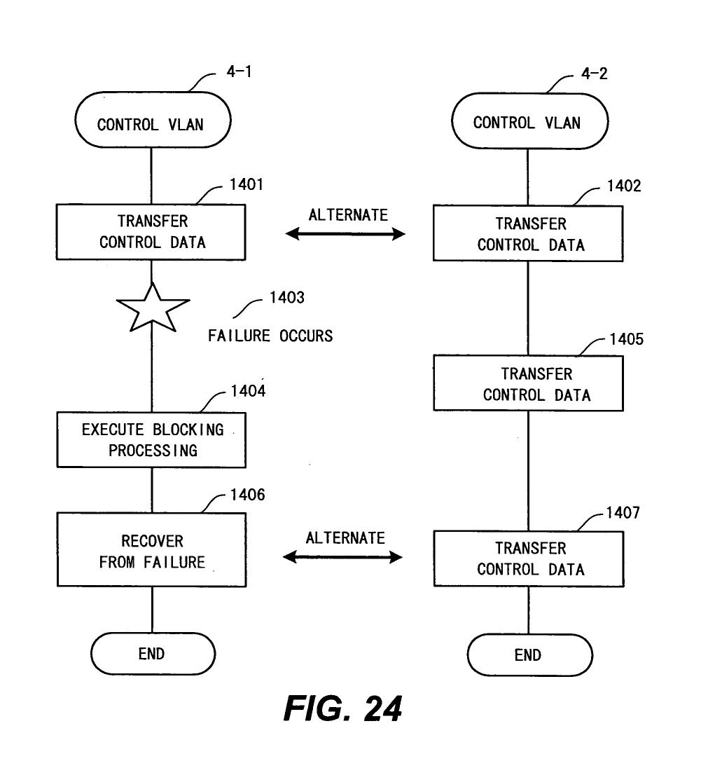

FIG. 24 is a flow chart of processing of the control VLANs 4-1 and 4-2 for when a fault occurs.

The terminals 10-1 to 10-n, 20-1 to 20-n, . . . , and n0-1 to n0-n and the NAS 1 usually use the duplicated control VLANs 4-1 and 4-2 by turns to communicate control information (1401, 1402).

When a fault occurs in the control VLAN 4-1 (1403), the NAS 1 cannot receive control data from the control VLAN 4-1 and it is thus judged that a fault has occurred in the control VLAN 4-1. As a fault in the control VLAN 4-1 is detected, the control VLAN 4-1 is blocked (a step 1404) and the other control VLAN 4-2 alone is used for communications (1405).

After the control VLAN 4-1 that has failed recovers, the NAS 1 uses both of the control VLANs 4-1 and 4-2 (alternately, for example) to communicate control data (1406, 1407).

In the sixth embodiment of this invention, the duplication of the control VLANs 4-1 and 4-2 allows one of the control VLANs 4-1 and 4-2 that has not failed to continue processing while the other that has failed recovers.

This invention is applicable to, for example, a network system that has NAS and that uses a VLAN, and can balance the network load throughout the user VLANs. This invention is also applicable to a network system that has such a storage control system as NAS head which has a control unit but not a disk drive and that uses a VLAN.

While the present invention has been described in detail and pictorially in the accompanying drawings, the present invention is not limited to such detail but covers various obvious modifications and equivalent arrangements, which fall within the purview of the appended claims.

What is claimed is:

1. A method of managing a network system comprising a computer device which processes data, a storage system which is used in the computer device to store data, and a switch which connects the computer device and the storage system to each other,
wherein the storage system sets VLANs and the priority of each of the VLANs on the switch, VLANs including at least one of a control VLAN transferring mainly control data, and at least one of a user VLAN transferring data other than the control data, and
wherein the switch transfers the data of the VLANs which are set as a higher priority before transferring the data of the VLANs which are set as a lower priority.

2. The method of managing a network system according to claim 1, wherein the storage system sets the priority of the control VLAN higher than the priority of the user VLAN.

3. The method of managing a network system according to claim 1, wherein the storage system sets the priority of event information of the control VLAN higher than the priority of traffic information of the control VLAN.

4. The method of managing a network system according to claim 1, wherein the storage system sets a high priority to event information of the control VLAN that is of great importance.

5. The method of managing a network system according to claim 1, wherein the storage system sets the priority of traffic information of the control VLAN that is of a great importance higher than the priority of traffic information of the control VLAN that is of small importance.

6. The method of managing a network system according to claim 1, wherein the storage system sends a priority modify packet on the switch which is directly connected to the storage system to thereby set the priority of the user VLAN on the switch.

7. The method of managing a network system according to claim 1,
wherein the switch directly connected to the storage system notifies another switch of the priority of the user VLAN that is set by the priority modify packet sent from the storage system, and
wherein the user VLAN priority is set to the other switch.

8. The method of managing a network system according to claim 1, wherein the storage system stores the priority for each of the VLANs.

9. The method of managing a network system according to claim 1, wherein the storage system receives event information from the control VLAN and sets the priority of the user VLAN on the switch in accordance with the received event information.

10. The method of managing a network system according to claim 9, wherein the switch receives event information from the computer device and then uses the control VLAN to send the event information to the storage system.

11. The method of managing a network system according to claim 1, wherein the storage system receives traffic information from the control VLAN and sets the priority of the user VLAN on the switch in accordance with the received traffic information.

12. The method of managing a network system according to claim 11, wherein the storage system stores the received traffic information, monitors a change in the stored traffic information and, upon a change of the traffic information, sets the priority of the user VLAN on the switch.

13. The method of managing a network system according to claim 11, wherein the switch measures the traffic volume of the user VLAN and sends traffic information, which is based on the measured traffic volume, to the storage system via the control VLAN.

14. The method of managing a network system according to claim 1, wherein the storage system controls the switch to prevents the use of the control VLAN.

15. The method of managing a network system according to claim 1,
wherein the storage system sets two or more control VLANs on the switch and transfers control data using all of the plural control VLANs, and
wherein, when receiving no control data from one of the control VLANs, the storage system judges that a fault has occurred in this control VLAN.

16. The method of managing a network system according to claim 15, wherein, when one of the control VLANs fails, the storage system blocks the failed control VLAN while transferring control data through the rest of the control VLANs.

17. The method of managing a network system according to claim 15,
wherein, when the failed control VLAN recovers, the storage system resumes the use of the recovered control VLAN in transfer of control data, and
wherein the storage system transfers control data using all of the plural control VLANs.

18. A storage system comprising:
a controller which controls data input/output to a disk drive where data is stored; and
a network interface which controls data transmission and reception to and from a network,
wherein the storage system is connected via a switch on the network to a computer device which receives data from the storage system to process the data, and
wherein a control VLAN, a user VLAN, and the priority of each of the VLANs are set on the switch, the control VLAN transferring mainly control data, the user VLAN transferring data other than the control data.

19. The storage system according to claim 18,
wherein the priority of the control VLAN is set higher than the priority of the user VLAN, and
wherein, upon reception of event information from the control VLAN, the priority of the user VLAN is set on the switch in accordance with the received event information.

20. A method of managing a network system comprising a computer device which processes data, a storage system, and an L2 switch which connects the computer device and the storage system to each other, the storage system comprising: a disk drive for data storage; a control unit for data input/output to the disk drive; and a network interface for control of data transmission and reception to and from a network,
wherein the storage system sets a control VLAN and a user VLAN on the L2 switch, VLANs including at least one of a control VLAN transferring mainly control data, and at least one of a user VLAN transferring user data,
wherein, upon reception of control information from the control VLAN, a priority modify packet is sent to the L2 switch directly connected to the storage system to thereby set the priority of the user VLAN to the L2 switch,
wherein the L2 switch notifies another L2 switch of the priority of user VLAN, and
wherein the set user VLAN priority is set to the other L2 switch.
